(19) United States
(12) Patent Application Publication
(10) Pub. No.: US 2026/0074772 A1
(43) Pub. Date: Mar. 12, 2026

(54) SIDELINK BEAM MANAGMENT WITH TRANSMITTER ROTATION

(71) Applicant: Apple Inc., Cupertino, CA (US)

(72) Inventors: Huaning Niu, San Jose, CA (US); Chunxuan Ye, San Diego, CA (US); Oghenekome Oteri, San Diego, CA (US); Wei Zeng, Saratoga, CA (US); Dawei Zhang, Saratoga, CA (US); Weidong Yang, San Diego, CA (US)

(21) Appl. No.: 19/267,800

(22) PCT Filed: Jan. 22, 2024
(86) PCT No.: PCT/US2024/012342

§ 371 Date: Jul. 14, 2025

Related U.S. Application Data
(60) Provisional application No. 63/484,358, filed on Feb. 10, 2023.

(51) Int. Cl. H04B 7/06; H04W 72/044; H04W 72/40

(52) U.S. Cl. CPC H04B 7/06958; H04B 7/06962; H04B 7/06964; H04W 72/046; H04W 72/40

(57) ABSTRACT

Systems, methods, and circuitries are provided for performing beamforming in sidelink communication. In one example, a method includes transmitting reference signals to a receiving (RX) UE using different transmit (TX) beams; receiving a signal indicative of an initial TX beam from the RX UE; detecting degradation of a link associated with the initial TX beam; and in response, selecting a revised TX beam for transmitting subsequent sidelink transmissions to the RX UE.

### CROSS REFERENCE TO RELATED APPLICATIONS

This application claims the benefit of priority from U.S. Provisional Patent Application Ser. No. 63/484,358 filed on Feb. 10, 2023, the contents of which are hereby incorporated by reference in their entirety.

### BACKGROUND

The present disclosure relates generally to wireless communication and more specifically to techniques for performing sidelink or device-to-device communication in a radio network.

### BRIEF DESCRIPTION OF THE DRAWINGS

Some examples of circuits, apparatuses and/or methods will be described in the following by way of example only. In this context, reference will be made to the accompanying figures.

FIG. 1 is a diagram of an example of a Uu link beam selection and refinement process between a radio access network (RAN) node and a user equipment (UE), in accordance with various aspects described.

FIG. 2 is a diagram of an example of a sidelink beam selection and refinement process between two UEs, in accordance with various aspects described.

FIG. 3 is a flow diagram outlining an example sidelink beam selection and maintenance process, in accordance with various aspects described.

FIGS. 4A and 4B illustrate translation of UE coordinates, in accordance with various aspects described.

FIG. 5 is a flow diagram outlining an example sidelink beam selection and maintenance process, in accordance with various aspects described.

FIG. 6 is a flow diagram outlining an example sidelink beam selection and maintenance process, in accordance with various aspects described.

FIG. 7 is a flow diagram outlining an example sidelink beam selection and maintenance process, in accordance with various aspects described.

FIGS. 8A, 8B, 8C, and 8D illustrate example slot configurations in which channel state information reference signals (CSI-RS) are time domain multiplexed (TDM) with respect to a physical sidelink control channel (PSCCH) and/or a physical sidelink shared channel (PSSCH), in accordance with various aspects described.

FIG. 9 is a flow diagram outlining an example method for selecting and maintaining sidelink beams, in accordance with various aspects described.

FIG. 10 is a flow diagram outlining an example method for selecting and maintaining sidelink beams, in accordance with various aspects described.

FIG. 11 is a functional block diagram of a wireless communication network, in accordance with various aspects described.

FIG. 12 illustrates a simplified block diagram of a user equipment device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration.

Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

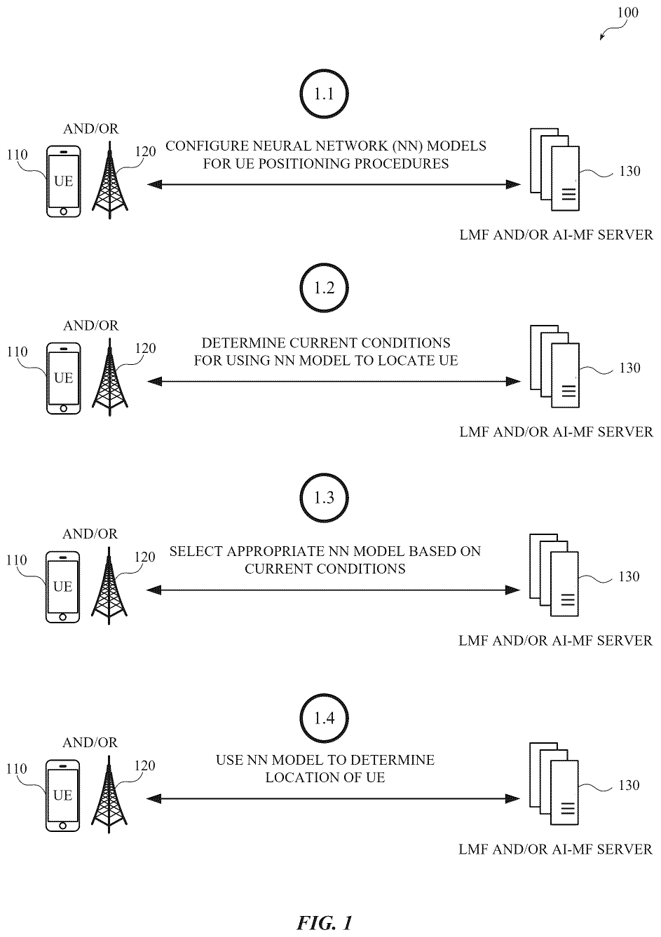

Beamforming is an important aspect of new radio (NR) communication in high frequency bands (e.g., frequency range 2 (FR2). Maintaining a high quality Uu link beam with a mobile user involves a significant amount of overhead signaling. FIG. 1 illustrates a three step beam management process that is employed to maintain the Uu link. Process P1 is used to select an optimal wide beam. A base station 110 transmits respective synchronization signal blocks (SSBs) using different wide transmit beams. The SSBs are transmitted sequentially in time (i.e., wide beam sweeping) with preconfigured offset between SSBs. A UE 120 receives the SSBs using a wide receive (RX) beam, and may sweep wide RX beams during the P1 process. Each SSB includes a primary synchronization signal (PSS) that encodes a physical layer cell identity (PCI) for the base station. The UE identifies an SSB that meets selection criteria (e.g., was optimally received) and reports this “optimal” or “best” beam (as identified by an associated SSB resource indicator (SSBRI)) to the base station. Factors that a UE may use in selecting the optimal beam include the relative signal-to-noise ratios (SNRs) of the received SSBs. During wide or narrow beam selection, the comparison of the different beams may be made based on reference signal received power (RSRP) measurements made on reference signals (e.g., SSB or CSI-RS) associated with each beam. In the illustrated example, the UE 120 selects SSB2 as the optimal wide beam.

P2 is a beam refinement process in which a narrower beam from within the selected wide beam is selected by the UE. The base station 110 sweeps narrower beams within the selected wide bean by sequentially transmitting respective channel state information reference signals (CSI-RS) on respective narrower beams that fall within the selected optimal wide beam. The UE reports the strongest narrower beam (as identified by an associated CSI-RS resource indicator (CRI)) to the base station. In the illustrated example, the selected narrow beam is associated (e.g., quasi co-located (QCLed) with CSI-RS 0.

The P1 wide beam selection and P2 transmitter narrow beam refinement processes are focused on the base station selecting an optimal transmit beam for a particular UE. In the P3 process, the UE selects an optimal narrow UE RX beam. After the base station receives the narrow beam selection from the UE, the base station repeatedly transmits CSI-RS (called “repeated CSI-RS” in this disclosure) on the selected narrow beam. The UE scans its narrow RX beams and selects the UE RX beam that optimally receives the CSI-RS. The UE 120 does not report its selected beam to the base station 110. The UE may sometimes trigger the base station to transmit a beam tracking reference signal (e.g., CSI-RS or repeated CSI-RS) to allow the UE to perform a subsequent UE beam refinement process as the UE moves or channel conditions change.

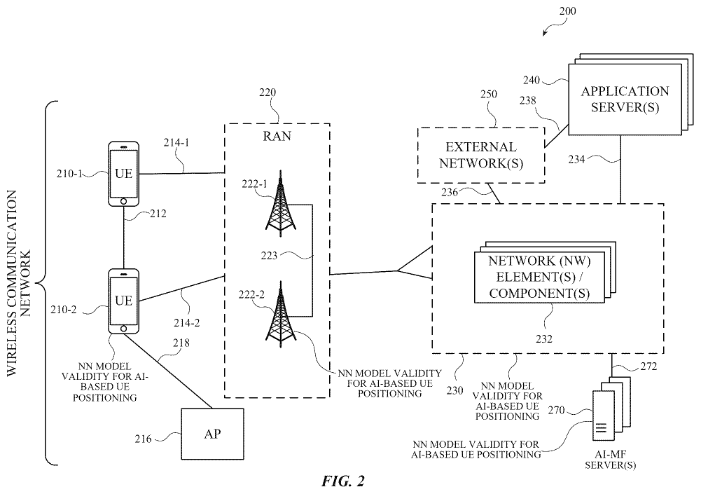

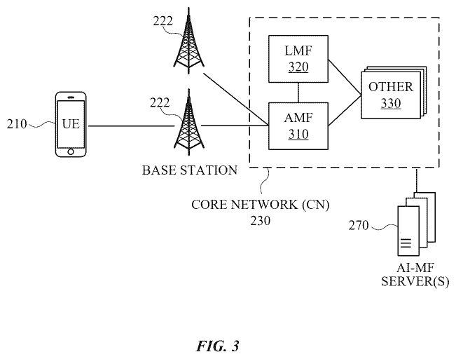

Beamforming in sidelink communication may utilize a similar beam selection and beam refinement process as outlined in FIG. 1 for the Uu link. However, there are some differences in sidelink communication and Uu link based communication that should be addressed to support sidelink beamforming. FIG. 2 illustrates an example sidelink beam selection/refinement process that is adapted from the P1,P2,P3 processes outlined in FIG. 1.

During a TX wide beam selection process, a transmitting (TX) UE 210 transmits S-SSBs. An RX UE 220 uses its wide RX beam to receive the S-SSBs and determine which S-SSB is optimally received. The RX UE 220 reports the optimal beam (e.g., as indicated by a sidelink SSBRI (S-SSBRI).

One challenge in adapting the beam selection process (P1) for the Uu link for use in selecting an optimal wide sidelink TX beam is that there are differences in the S-SSBs sent by UEs for sidelink communication as compared to the SSBs sent by base stations. To support sidelink communication, UEs transmit sidelink SSBs (S-SSBs). The S-SSBs include an SSID that indicates a type and source of synchronization provided by the TX UE. For example, the SSID may indicate that the UE is directly synchronized to a particular base station, indirectly synchronized to a particular base station through a UE that is directly synchronized to the base station, synchronized to a global navigation satellite system (GNSS), and so on. This allows UEs that may be out of range of a base station to find a suitable UE from which to receive timing signals. In one aspect, sidelink communication may enabled for UEs having a same SSID, which means that they derive their synchronization from a same source (e.g., a same base station or UE) and UEs having different SSIDs may not be enabled for sidelink communication with each other.

The SSIDs are assigned based on the synchronization source and type of synchronization the UE provides, but do not indicate a unique identity of the UE. When sidelink communication is configured between two UEs destination and source identifiers are configured (e.g., by an application layer) at that time through sidelink control information (SCI). Thus, unlike the Uu link beam selection procedure in which the UE can determine the PCI from the SSB, a UE receiving S-SSB will not know the identity of the UE that is transmitting the S-SSB. This means that the SSID may not provide sufficient information for use in selecting sidelink beams.

Picking up with the sidelink beam selection process of FIG. 2, it is assumed that the S-SSB or other signaling allows the RX UE 220 to associate a given S-SSB with a particular TX UE. In response to the reporting of the optimal wide beam by the RX UE 220, during a TX narrow beam selection process the TX UE 210 transmits CSI-RS and the RX UE reports the optimal narrow beam (e.g., as indicated by a sidelink CRI (S-CRI). During an RX beam refinement process, the TX UE 210 transmits repeated CSI-RS on the selected narrow beam for use by the RX UE 220 in selecting its optimal RX beam.

In the Uu link related beamforming processes, the beamforming transmitter (e.g., base station) of the SSB and CSI-RS used for beam selection and refinement is typically fixed, meaning that in the majority of use cases it is channel degradation caused by significant movement of the RX UE that will trigger beam re-selection (e.g., P1/P2). The P3 used by the RX UE to adapt its RX beam in response to channel degradation caused by its own motion represents a relatively low signaling overhead as compared to signaling associated with the P1/P2 processes.

When the beamforming transmitter is itself a mobile device (i.e., a UE as compared to a base station), movement of the transmitter is expected, which may require frequent triggering of the wide TX beam and narrow TX beam selection/refinement processes. This may incur significant signaling overhead, and present a challenge to supporting beamforming in sidelink communication.

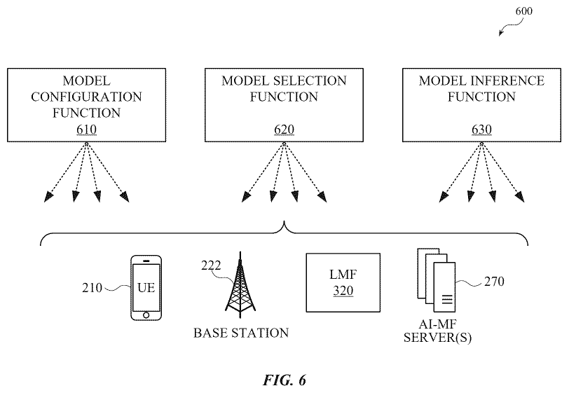

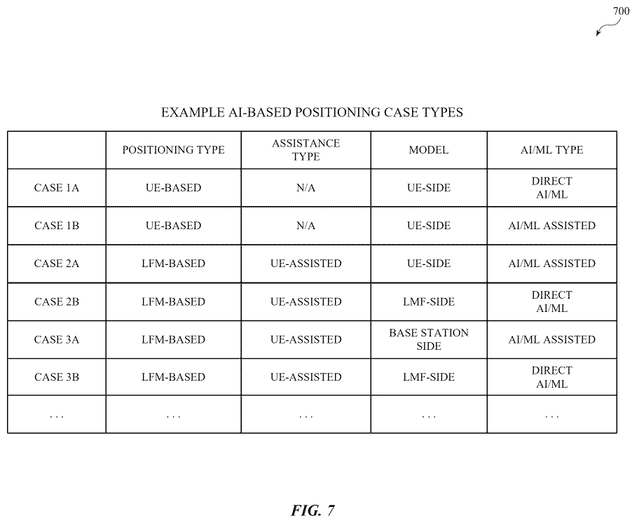

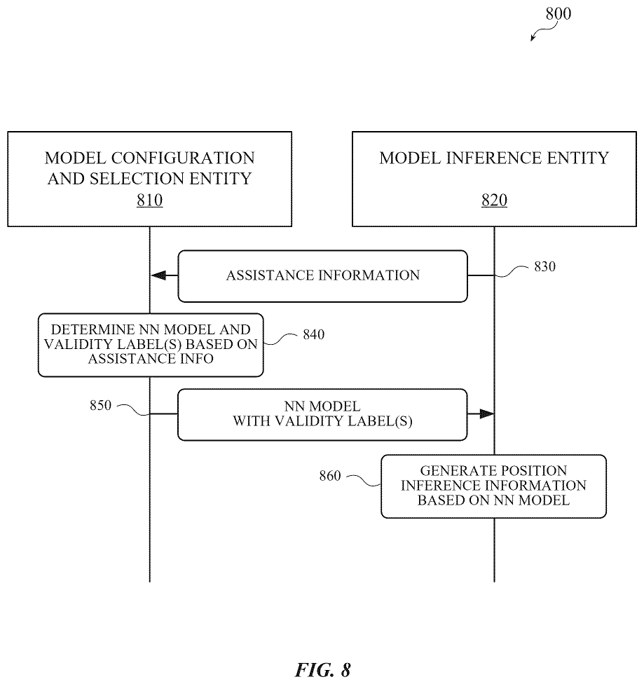

FIGS. 3-10 outline several techniques for sidelink beamforming that address some of the challenges in adapting the Uu link beamforming procedures for sidelink beamforming. FIGS. 3-5 illustrate UE motion sensor-based compensation techniques for TX UE motion and FIGS. 6 and 7 illustrate techniques that do not rely on motion sensors in the TX UE.

FIG. 3 is a flow diagram illustrating an example of a first UE motion sensor-based technique for changing a sidelink TX beam when a TX UE 310 changes orientation. The TX UE transmits reference signals for beam management (e.g., SSBs, CSI-RS, and/or repeated CSI-RS) at 330 and an RX UE 320 transmits beam selection feedback 340. Messages 330 and 340 are generalized for simplicity and, as shown in FIG. 2, the TX UE 310 may transmit different beam management related reference signals in successive message exchanges and the RX UE may transmit corresponding successive beam selection feedback (e.g., S-SSBRI, S-CRI). The TX UE transmits PSCCH and PSSCH 350 using the beam selected in 340. When the TX UE 310 detects a change in its orientation (e.g., based on motion sensor data), at 360 the TX UE selects a new TX beam that has a same beam direction with respect to global co-ordinates established based on the beam selected in 340.

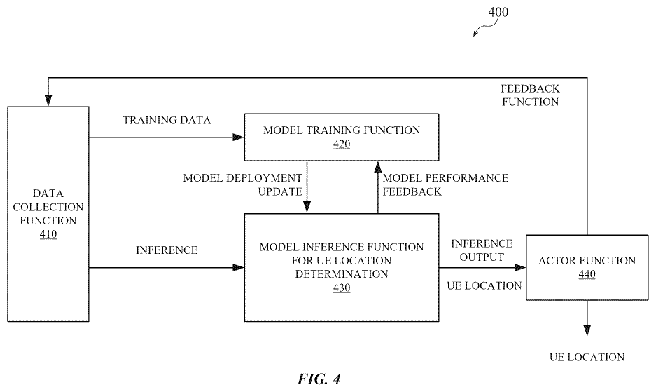

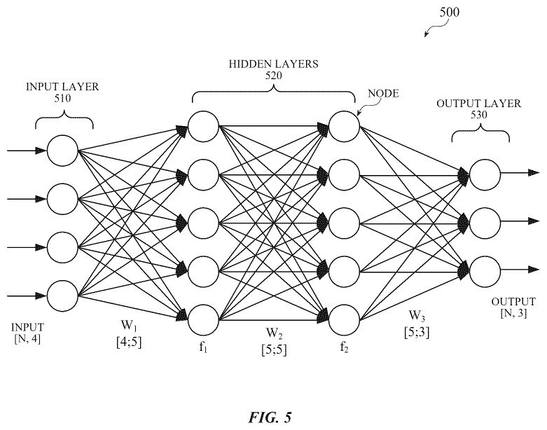

FIGS. 4A and 4B illustrates the selection of the new TX beam based on a translation of UE coordinates. In FIG. 4A, the TX UE 310 is using a beam associated with SSB0 to transmit PSCCH and PSSCH. A “global” axis of communication between the TX UE 310 and the RX UE 320 is established by the TX beam. Prior to a change in orientation, the local axis of the sidelink communication corresponds to the global axis. In FIG. 4B, the TX UE 310 has rotated in the X-Y plane so that the local axis of the TX UE 310 is rotationally offset from the global axis by approximately 40°. The TX UE 310 detects this 40° change in orientation (e.g., based on internal sensor data or other means) and finds the SSB that is mapped to an axis 40° from SSB0, or SSB3. The TX UE 310 may also find a narrow beam within the wide beam associated with SSB3 that is optimally aligned with the original TX beam. This technique may be enabled by motion sensors in the TX UE and a TX UE capability for mapping beams in to a local orientation with respect to a global orientation. While the change in orientation in FIG. 4 is in two dimensions, the technique may be performed to compensate for three dimensional changes in orientation.

Returning to FIG. 3, the TX UE 310 transmits PSCCH and PSSCH 370 using the new TX beam. The RX UE 320 does not need to adapt its RX beam and the change in TX beam from the TX UE perspective may be transparent with respect to the RX UE. When the TX UE 310 detects another change in its orientation, at 380 the TX UE selects a new TX beam that has a same beam direction with respect to global co-ordinates established based on the beam selected in 340 or 360.

FIG. 5 is a flow diagram illustrating an example of a second UE motion sensor-based technique for changing a sidelink TX beam when a TX UE 510 changes orientation. The TX UE 510 transmits reference signals for beam management (e.g., SSBs, CSI-RS, and/or repeated CSI-RS) at 525 and an RX UE 520 transmits beam selection feedback 530. Messages 525 and 530 are generalized for simplicity and, as shown in FIG. 2, the TX UE 510 may transmit different beam management related reference signals in successive message exchanges and the RX UE may transmit corresponding successive beam selection feedback (e.g., S-SSBRI, S-CRI). The TX UE transmits PSCCH and PSSCH 540 using the beam selected in 530. When the TX UE 510 detects a change in its orientation (e.g., based on motion sensor data), the UE triggers a new beam management process to select a new TX beam, resulting in messages 545 and 550 (generalized as described above). The TX UE 510 transmits PSCCH and PSSCH 555 using the new TX beam. When the TX UE 510 detects another change in its orientation (e.g., based on motion sensor data), the UE triggers a new beam management process to select a new TX beam, resulting in messages 560 and 565 (generalized as described above). The TX UE 510 transmits PSCCH and PSSCH 570 using the new TX beam.

In one example, the beam re-selection process triggered by the TX UE depends on the magnitude or direction of change in orientation. For example, the TX UE 510 may not trigger a wide beam selection (e.g., via S-SSBs) when a slight change in orientation is detected, but rather may trigger a narrow beam refinement (e.g., via CSI-RS or repeated CSI-RS).

FIG. 6 is a flow diagram outlining a message exchange associated with sidelink beam selection that is not based on a TX UE detecting its own orientation change. In this example, a TX UE 610 continues to send beam tracking reference signals (e.g., CSI-RS, repeated CSI-RS) and receive feedback (e.g., S-SSBRI, S-CRI) regarding a selected beam from an RX UE 620. In this manner, link degradation due to TX UE motion should trigger a beam re-selection by the RX UE. The TX UE 610 transmits reference signals for beam management at 625 and the RX UE 620 transmits beam selection feedback 630. Messages 625 and 630 are generalized for simplicity and, as shown in FIG. 2, the TX UE 610 may transmit different beam management related reference signals in successive message exchanges and the RX UE may transmit corresponding successive beam selection feedback (e.g., S-SSBRI followed by S-CRI). The TX UE transmits PSCCH and PSSCH 640 using the beam selected in 630. The TX UE 610 periodically (e.g., not only in response to a request from the RX UE) sends beam tracking reference signals 645 and receives beam selection feedback 650. If the link quality remains satisfactory (e.g., the TX UE has not significantly changed orientation), the beam selection feedback 650 will indicate the same TX beam as was indicated at 630.

At some point the TX UE may experience a change in orientation. After this change in orientation the TX UE will send periodic or aperiodic beam tracking reference signals 660.

The RX UE 620 transmits feedback 665 indicating a new TX beam. In response, the TX UE 610 updates the TX beam to the new TX beam (e.g., by way of updating the active transmission configuration indicator (TCI) state).

The solutions outlined in FIGS. 3-6 are disclosed based on an assumption of beam correspondence, meaning that the optimal RX beam for receiving from a given UE corresponds to an optimal TX beam for transmitting to the given UE. It is noted that the solutions of FIGS. 3-6 may be extended to cover the case when beam correspondence is not assumed. In these instances, reciprocal beam selection signaling for selecting an optimal RX beam is performed in addition to the disclosed signaling for selecting an optimal TX beam.

FIG. 7 is a flow diagram outlining an exchange of messages for sidelink beam maintenance that does not rely on beam selection feedback between the UEs. The process outlined in FIG. 7 relies on beam correspondence with each UE continuously performing RX beam tracking. Each UE uses the latest optimal RX beam as a TX beam for transmitting PSCCH and PSSCH. Synchronization messages 730 are exchanged to synchronize a first UE 710 and a second UE 720 and to select an initial beam (see, e.g., FIG. 2). After synchronization, the UEs exchange beam tracking signals, for example the second UE 720 transmits beam tracking reference signals (e.g., repeated CSI-RS or CSI-RS) 735 on an optimal TX beam corresponding to its optimal RX beam. At 740, the first UE 710 selects an optimal TX beam corresponding to its optimal RX beam for receiving the beam tracking reference signals 735. The optimal TX beam may be the same TX beam as was determined at 720 or a new TX beam.

The first UE 710 transmits beam tracking reference signals 750 on the optimal TX beam. At 760, the second UE 720 selects an optimal TX beam corresponding to its optimal RX beam for receiving the beam tracking reference signals 750. The second UE 720 transmits beam tracking reference signals 770 on the optimal TX beam. A change in orientation of the first UE 710 may change the optimal RX beam for receiving the beam tracking reference signals 770. At 780, the first UE 710 selects an optimal TX beam corresponding to its optimal RX beam for receiving the beam tracking reference signals 770, thereby correcting the beam to compensate for its change in orientation. The first UE uses the optimal TX beam as determined at 780 to transmit PSSCH and/or PSCCH 790.

### S-SSB With Enhanced CSI-RS

The solutions discussed with respect to FIGS. 3-7 rely on beam tracking signaling transmitted by a UE that may also be transmitting PSCCH and/or PSSCH. Since beam tracking reference signals such as CSI-RS and repeated CSI-RS should be time domain multiplexed (TDM) with respect to PSCCH and PSSCH, this may result in burdensome overhead for frequent beam changes. FIGS. 8A-8D illustrate slot configurations in which PSCCH and PSSCH are time TDM with CSI-RS (or CSI-RS) to reduce beam tracking overhead. In FIG. 8A a slot configuration 810 is shown that includes a first orthogonal frequency division multiplexing (OFDM) symbol allocated for carrying automatic gain control (AGC), two symbols carrying PSCCH, and the remaining symbols carrying CSI-RS. FIG. 8B illustrates a slot configuration 820 that includes a first symbol allocated for carrying automatic gain control (AGC), two symbols carrying PSCCH, seven symbols carrying PSSCH, and the remaining four symbols carrying CSI-RS.

Overhead associated with having several symbols carrying CSI-RS as in the PSCCH/PSSCH slots 810 or 820 may be reduced as illustrated in FIGS. 8C and 8D. Cyclic prefix (CP) is shown in dark grey shading in the exploded views. As shown in a slot configuration 830 of FIG. 8C, while the PSCCH and PSSCH are transmitted at 120 KHz, a symbol carrying CSI-RS may be transmitted with a higher subcarrier spacing (SCS) 480 kHz.

The time overhead associated with transmitting the CSI-RS symbols is reduced by a factor of four and three additional symbols are made available for PSSCH. Alternatively, as shown in a slot configuration 840 of FIG. 8C, the CSI-RS in the last symbol(s) may be down-sampled in the frequency domain and transmitted in a time duration corresponding to one symbol. The factor of four reduction illustrated in FIGS. 8C and 8D are based on an UE having four times subcarrier spacing or four times frequency domain down-sampling. For a UE having two times subcarrier spacing or two times frequency domain down-sampling, the overhead associated with transmitting four CSI-RS symbols would be reduced by a factor of two, and two symbols would carry CSI-RS.

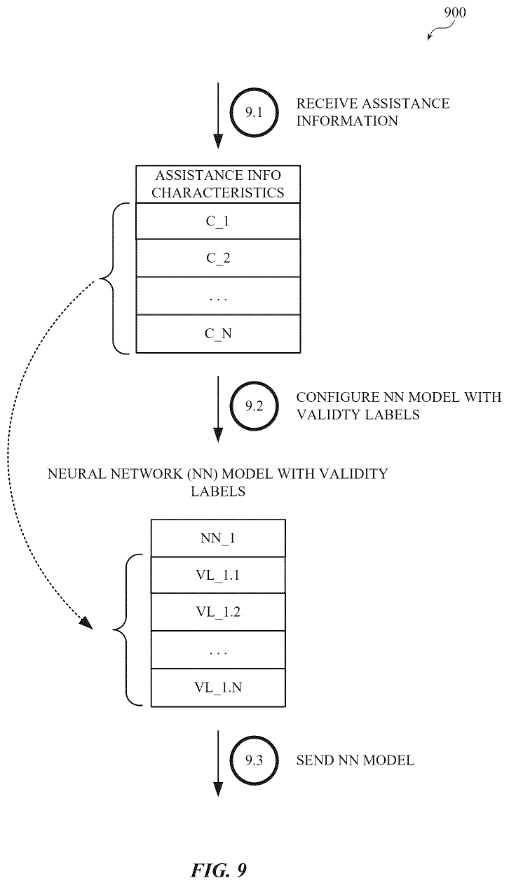

FIG. 9 is a flow diagram outlining a method 900 for performing sidelink communication. The method 900 may be performed by a TX UE (e.g. TX UE 310, 510, 610 of FIGS. 3, 5, 6, respectively). The method includes, at 910, transmitting reference signals to a receiving (RX) UE using different transmit (TX) beams. At 920 a signal indicative of an initial TX beam is received from the RX UE. A physical sidelink control channel (PSCCH) or physical sidelink shared channel (PSSCH) (PSCCH/PSSCH) is transmitted using the initial TX beam at 930. At 940, the method includes detecting degradation of a link associated with the initial TX beam. At 950, in response, a revised TX beam is selected for transmitting subsequent PSCCH/PSSCH to the RX UE.

In one example, the degradation of the link associated with the initial beam is detected based on a change in orientation of the UE. In one example, as disclosed with reference to FIGS. 3 and 4, the method includes detecting the degradation of the link by sensing a change in orientation of the UE with respect to a global TX axis aligned with the initial TX beam. In response, a TX beam having a local TX axis that is aligned with the global TX axis is selected as the revised TX beam. In another example, as disclosed with reference to FIG. 5, the method includes detecting the degradation of the link by sensing a change in orientation of the UE. Based on the change in orientation, a TX wide beam selection related reference signal or a TX narrow beam selection related reference signal is transmitted to trigger selection of the revised TX beam.

In one example, as illustrated in FIG. 7, the method includes periodically or aperiodically transmitting a beam tracking reference signal (e.g., CSI-RS, repeated CSI-RS, and so on); and detecting the degradation of the link based on feedback (e.g., a beam selection signal) from the RX UE with respect to the beam tracking reference signal.

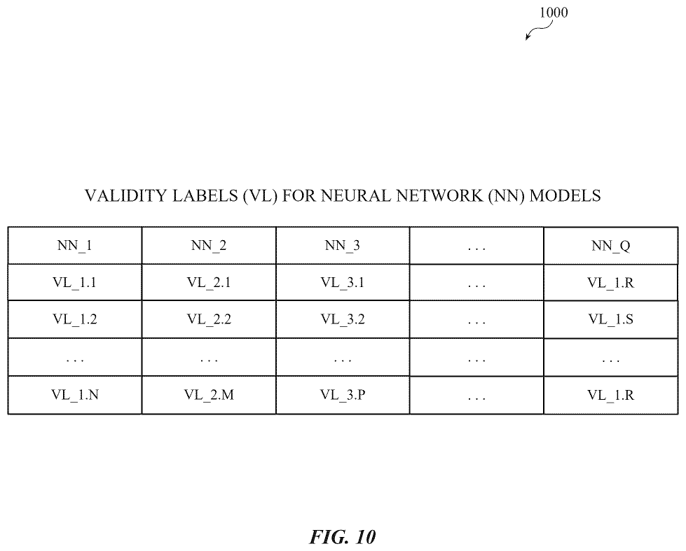

FIG. 10 is a flow diagram outlining a method 1000 for performing sidelink communication. The method 1000 may be performed by a UE (e.g. UE 710 or UE 720 of FIG. 7). The method includes, at 1010 receiving a first beam tracking reference signal from a receiving (RX) UE. At 1020, the method includes transmitting PSCCH/PSSCH using a first TX beam that corresponds to an optimal RX beam for receiving the first beam tracking reference signal. At 1030 a second beam tracking reference signal is transmitted using the first TX beam. At 1040, a third beam tracking reference signal is received from the RX UE. The method includes, at 1050, transmitting PSCCH/PSSCH using a second TX beam that corresponds to an optimal RX beam for receiving the third beam tracking reference signal.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

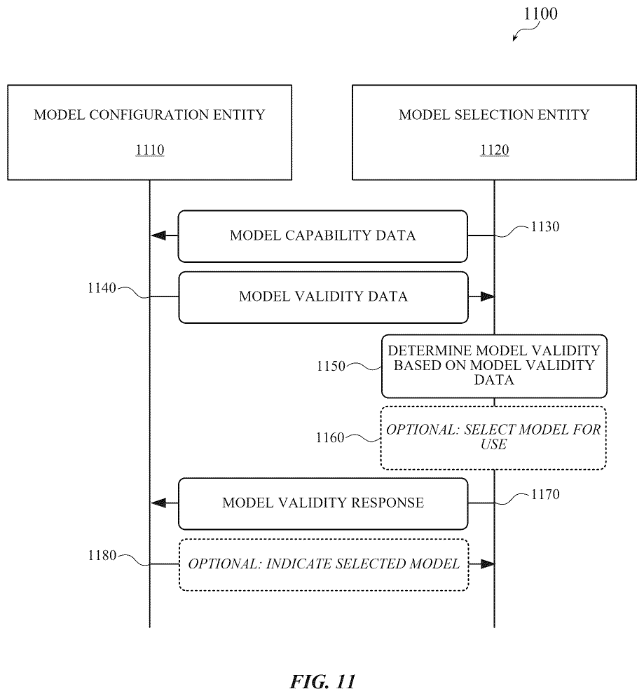

FIG. 11 is an example network 1100 according to one or more implementations described herein. Example network 1100 may include UEs 1110-1, 1110-2, etc. (referred to collectively as “UEs 1110” and individually as “UE 1110”), a radio access network (RAN) 1120, a core network (CN) 1130, application servers 1140, and external networks 1150.

The systems and devices of example network 1100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 1110 may include smartphones (e.g., handheld touchscreen mobile computing devices connectable to one or more wireless communication networks). Additionally, or alternatively, UEs 1110 may include other types of mobile or non-mobile computing devices capable of wireless communications, such as personal data assistants (PDAs), pagers, laptop computers, desktop computers, wireless handsets, watches etc. In some implementations, UEs 1110 may include internet of things (IoT) devices (or IoT UEs) that may comprise a network access layer designed for low-power IoT applications utilizing short-lived UE connections.

Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 1110 may use stored sidelink beam management instructions and information for performing one or more of the solutions disclosed with reference to FIGS. 3-10 to communicate and establish a beamformed connection with one or more other UEs 1110 via one or more wireless channels 1112, each of which may comprise a physical communications interface/layer. The connection may include an M2M connection, MTC connection, D2D connection, SL connection, etc. The connection may involve a PC5 interface. In some implementations, UEs 1110 may be configured to discover one another, negotiate wireless resources between one another, and establish connections between one another, without intervention or communications involving RAN node 1122 or another type of network node. In some implementations, discovery, authentication, resource negotiation, registration, etc., may involve communications with RAN node 1122 or another type of network node.

UEs 1110 may use one or more wireless channels 1112 to communicate with one another. As described herein, UE 1110-1 may communicate with RAN node 1122 to request SL resources. RAN node 1122 may respond to the request by providing UE 1110 with a dynamic grant (DG) or configured grant (CG) regarding SL resources. A DG may involve a grant based on a grant request from UE 1110. A CG may involve a resource grant without a grant request and may be based on a type of service being provided (e.g., services that have strict timing or latency requirements). UE 1110 may perform a clear channel assessment (CCA) procedure based on the DG or CG, select SL resources based on the CCA procedure and the DG or CG; and communicate with another UE 1110 based on the SL resources. The UE 1110 may communicate with RAN node 1122 using a licensed frequency band and communicate with the other UE 1110 using an unlicensed frequency band.

UEs 1110 may communicate and establish a connection with (e.g., be communicatively coupled) with RAN 1120, which may involve one or more wireless channels 1114-1 and 1114-2, each of which may comprise a physical communications interface/layer.

As described herein, UE 1110 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 1110 may also, or alternatively, connect to access point (AP) 1116 via connection interface 1118, which may include an air interface enabling UE 1110 to communicatively couple with AP 1116. AP 1116 may comprise a wireless local area network (WLAN), WLAN node, WLAN termination point, etc. The connection 1118 may comprise a local wireless connection, such as a connection consistent with any IEEE 702.11 protocol, and AP 1116 may comprise a wireless fidelity (Wi-Fi®) router or other AP. While not explicitly depicted in FIG. 11, AP 1116 may be connected to another network (e.g., the Internet) without connecting to RAN 1120 or CN 1130.

RAN 1120 may include one or more RAN nodes 1122-1 and 1122-2 (referred to collectively as RAN nodes 1122, and individually as RAN node 1122) that enable channels 1114-1 and 1114-2 to be established between UEs 1110 and RAN 1120. RAN nodes 1122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1122 may include a roadside unit (RSU), a transmission reception point (TRxP or TRP), and one or more other types of ground stations (e.g., terrestrial access points). In some scenarios, RAN node 1122 may be a dedicated physical device, such as a macrocell base station, and/or a low power (LP) base station for providing femtocells, picocells or the like having smaller coverage areas, smaller user capacity, or higher bandwidth compared to macrocells.

In some implementations, a downlink resource grid may be used for downlink transmissions from any of the RAN nodes 1122 to UEs 1110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

The RAN nodes 1122 may be configured to communicate with one another via interface 1123. In implementations where the system is an LTE system, interface 1123 may be an X2 interface. In NR systems, interface 1123 may be an Xn interface. The X2 interface may be defined between two or more RAN nodes 1122 (e.g., two or more eNBs/gNBs or a combination thereof) that connect to evolved packet core (EPC) or CN 1130, or between two eNBs connecting to an EPC.

As shown, RAN 1120 may be connected (e.g., communicatively coupled) to CN 1130. CN 1130 may comprise a plurality of network elements 1132, which are configured to offer various data and telecommunications services to customers/subscribers (e.g., users of UEs 1110) who are connected to the CN 1130 via the RAN 1120. In some implementations, CN 1130 may include an evolved packet core (EPC), a 5G CN, and/or one or more additional or alternative types of CNs. The components of the CN 1130 may be implemented in one physical node or separate physical nodes including components to read and execute instructions from a machine-readable or computer-readable medium (e.g., a non-transitory machine-readable storage medium As shown, CN 1130, application servers 1140, and external networks 1150 may be connected to one another via interfaces 1134, 1136, and 1138, which may include IP network interfaces.

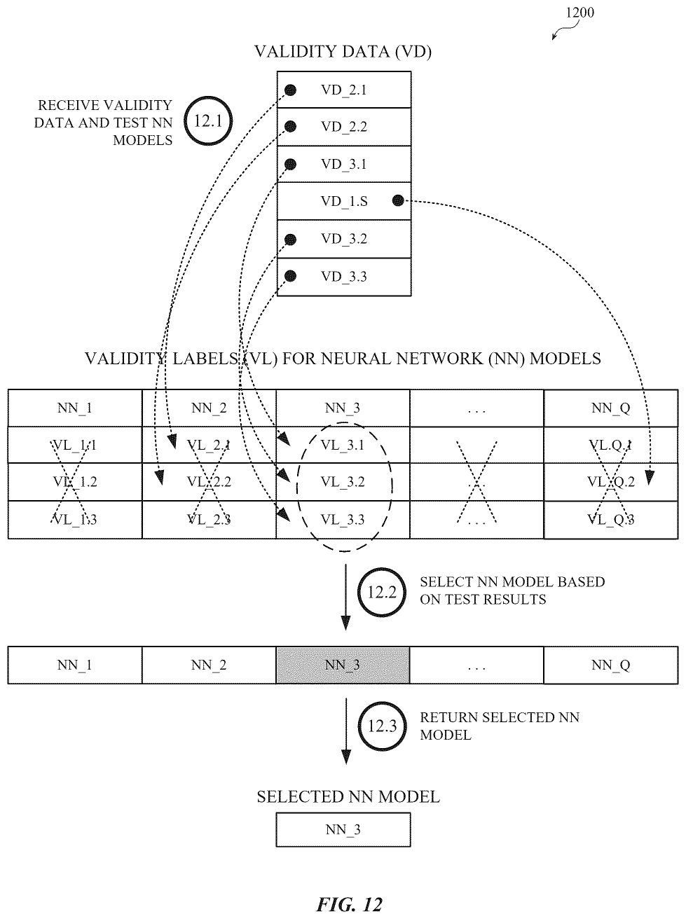

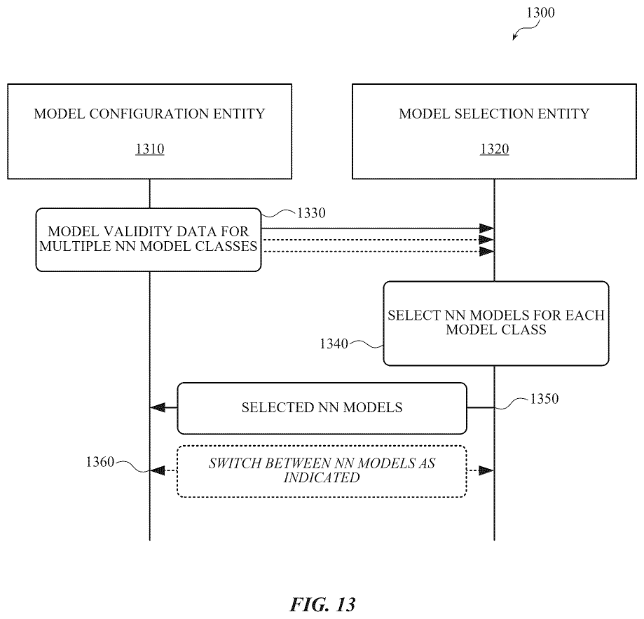

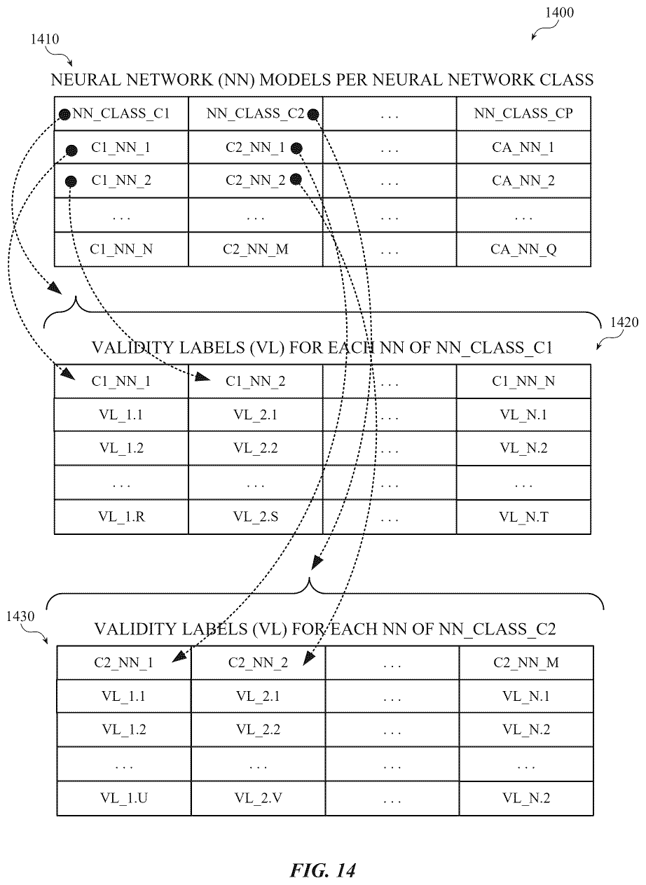

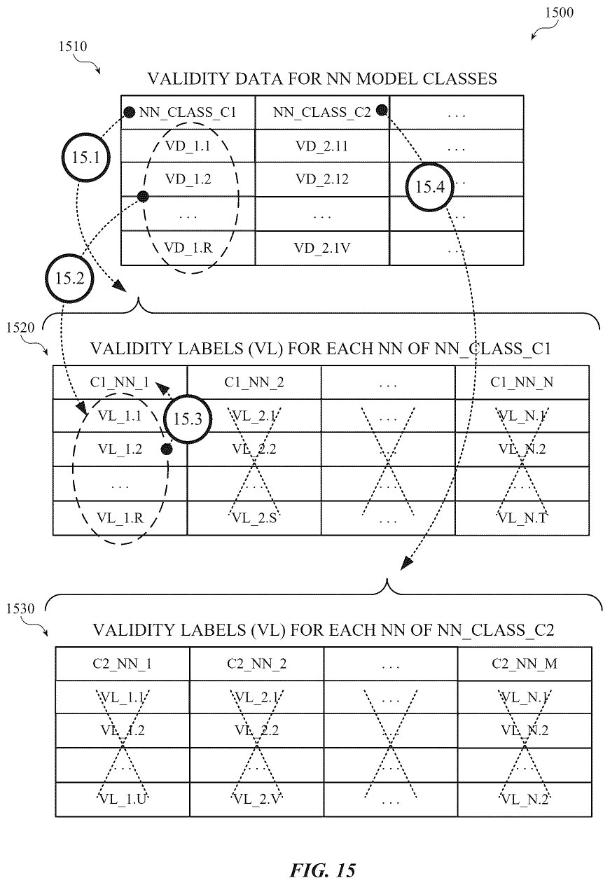

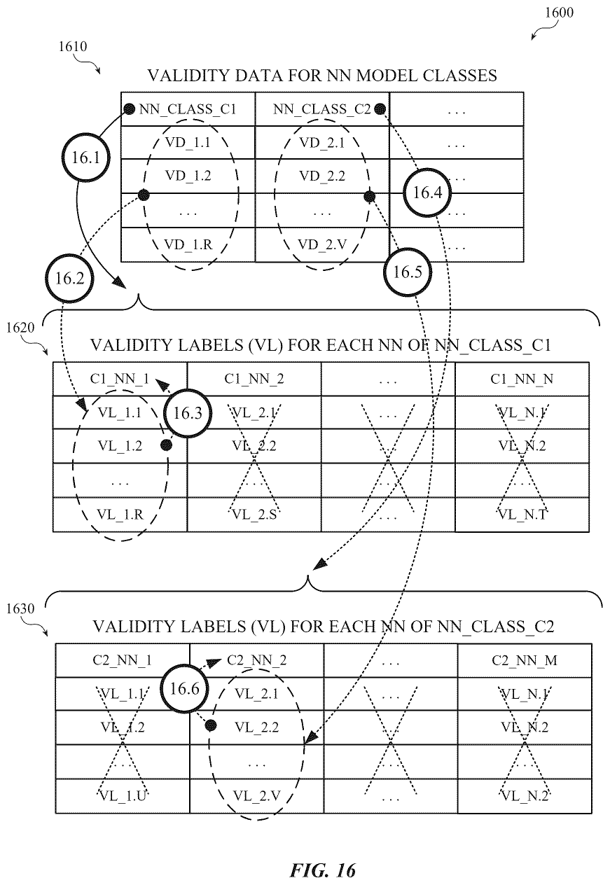

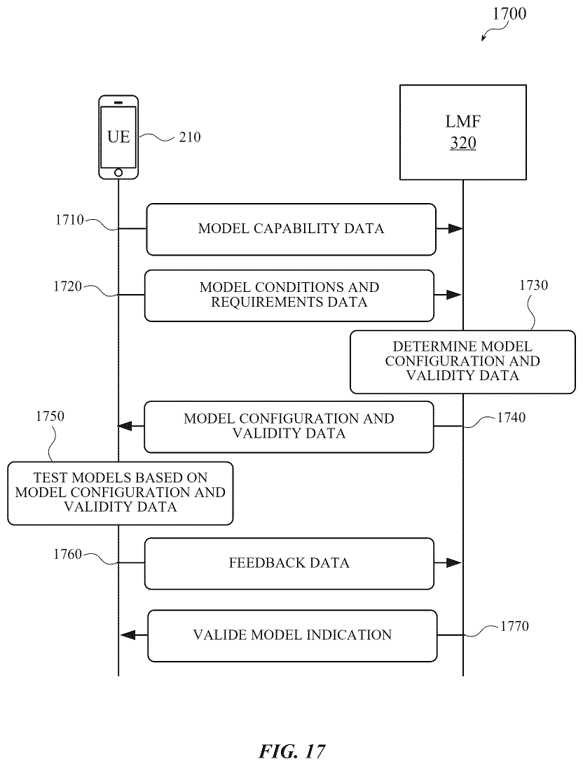

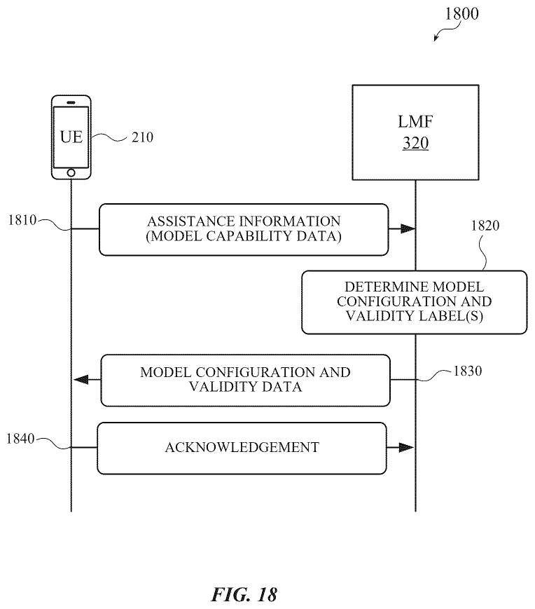

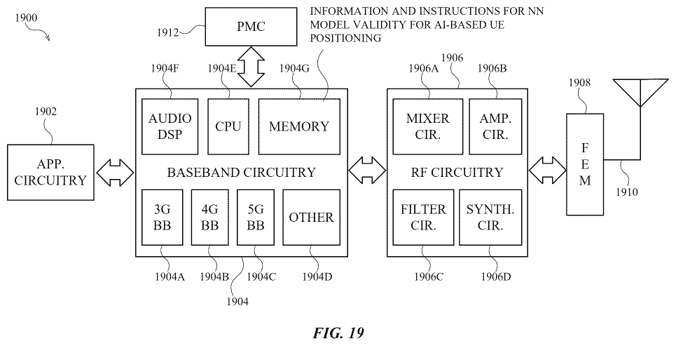

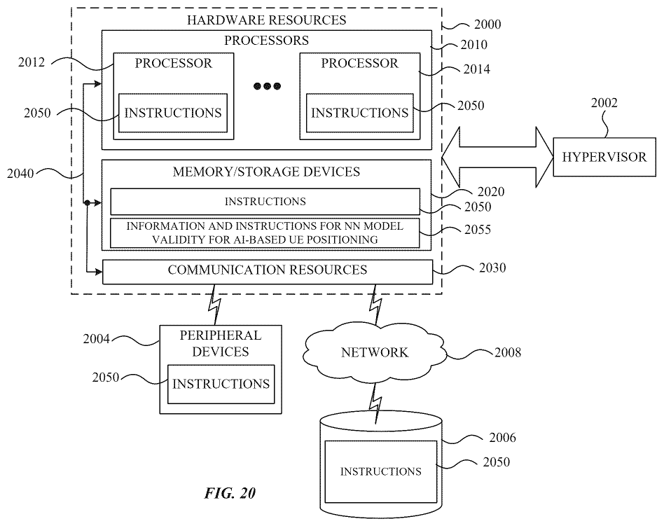

FIG. 12 is a diagram of an example of components of a network device according to one or more implementations described herein. In some implementations, the device 1200 can include application circuitry 1202, baseband circuitry 1204, RF circuitry 1206, front-end module (FEM) circuitry 1208, one or more antennas 1210, and power management circuitry (PMC) 1212 coupled together at least as shown. The components of the illustrated device 1200 can be included in a UE or a RAN node. In some implementations, the device 1200 can include fewer elements (e.g., a RAN node may not utilize application circuitry 1202, and instead include a processor/controller to process IP data received from a CN or an Evolved Packet Core (EPC)). In some implementations, the device 1200 can include additional elements such as, for example, memory/storage, display, camera, sensor (including one or more temperature sensors, such as a single temperature sensor, a plurality of temperature sensors at different locations in device 1200, etc.), or input/output (I/O) interface. In other implementations, the components described below can be included in more than one device (e.g., said circuitries can be separately included in more than one device for Cloud-RAN (C-RAN) implementations).

The application circuitry 1202 can include one or more application processors. For example, the application circuitry 1202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1200. In some implementations, processors of application circuitry 1202 can process IP data packets received from an EPC.

The baseband circuitry 1204 can include circuitry such as, but not limited to, one or more single-core or multi-core processors. The baseband circuitry 1204 can include one or more baseband processors or control logic to process baseband signals received from a receive signal path of the RF circuitry 1206 and to generate baseband signals for a transmit signal path of the RF circuitry 1206. Baseband circuity 1204 can interface with the application circuitry 1202 for generation and processing of the baseband signals and for controlling operations of the RF circuitry 1206. For example, in some implementations, the baseband circuitry 1204 can include a 3G baseband processor 1204A, a 4G baseband processor 1204B, a 5G baseband processor 1204C, or other baseband processor(s) 1204D for other existing generations, generations in development or to be developed in the future (e.g., 5G, 6G, etc.).

The baseband circuitry 1204 (e.g., one or more of baseband processors 1204A-D) can handle various radio control functions that enable communication with one or more radio networks via the RF circuitry 1206. In other implementations, some or all of the functionality of baseband processors 1204A-D can be included in modules stored in the memory 1204G and executed via a Central Processing Unit (CPU) 1204E. In some implementations, the baseband circuitry 1204 can include one or more audio digital signal processor(s) (DSP) 1204F.

In some implementations, memory 1204G may receive and/or store sidelink beamforming instructions and information that cause the device 1200 to act as a TX UE and/or RX UE as disclosed with reference to FIGS. 3-8.

RF circuitry 1206 can enable communication with wireless networks using modulated electromagnetic radiation through a non-solid medium. In various implementations, the RF circuitry 1206 can include switches, filters, amplifiers, etc. to facilitate the communication with the wireless network. RF circuitry 1206 can include a receive signal path which can include circuitry to down-convert RF signals received from the FEM circuitry 1208 and provide baseband signals to the baseband circuitry 1204. RF circuitry 1206 can also include a transmit signal path which can include circuitry to up-convert baseband signals provided by the baseband circuitry 1204 and provide RF output signals to the FEM circuitry 1208 for transmission.

In some implementations, the receive signal path of the RF circuitry 1206 can include mixer circuitry 1206A, amplifier circuitry 1206B and filter circuitry 1206C. In some implementations, the transmit signal path of the RF circuitry 1206 can include filter circuitry 1206C and mixer circuitry 1206A. RF circuitry 1206 can also include synthesizer circuitry 1206D for synthesizing a frequency for use by the mixer circuitry 1206A of the receive signal path and the transmit signal path.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

### EXAMPLES

Example 1 is a user equipment (UE), including a memory and a baseband processor coupled to the memory. The baseband processor is configured to, when executing instructions stored in the memory, cause the UE to transmit reference signals to a receiving (RX) UE using different transmit (TX) beams; receive a signal indicative of an initial TX beam from the RX UE; transmit physical sidelink control channel or physical sidelink shared channel (PSCCH/PSSCH) using the initial TX beam; detect degradation of a link associated with the initial TX beam; and in response, select a revised TX beam for transmitting subsequent PSCCH/PSSCH to the RX UE.

Example 2 includes the subject matter of example 1, including or omitting optional elements, wherein the degradation of the link associated with the initial TX beam is detected based on a change in orientation of the UE.

Example 3 includes the subject matter of any of examples 1-2, including or omitting optional elements, wherein the baseband processor is configured to sense a change in orientation of the UE with respect to a global TX axis, wherein the global TX axis is aligned with the initial TX beam; and select a TX beam having a local TX axis that is aligned with the global TX axis as the revised TX beam.

Example 4 includes the subject matter of any of examples 1-3, including or omitting optional elements, wherein the baseband processor is configured to sense a change in orientation of the UE; and based on the change in orientation, transmit a TX wide beam selection related reference signal or a TX narrow beam selection related reference signal to trigger selection of the revised TX beam.

Example 5 includes the subject matter of any of examples 1-4, including or omitting optional elements, wherein the baseband processor is configured to periodically transmit a beam tracking reference signal; and detect the degradation of the link based on feedback with respect to the beam tracking reference signal from the RX UE.

Example 6 includes the subject matter of any of examples 1-5, including or omitting optional elements, wherein the baseband processor is configured to transmit a beam tracking reference signal in a same slot as the PSCCH/PSSCH, wherein symbols used for transmitting the beam tracking reference signal are time domain multiplexed with respect to symbols that carry the PSCCH/PSSCH.

Example 7 includes the subject matter of any of examples 1-6, including or omitting optional elements, wherein the baseband processor is configured to transmit a beam tracking reference signal in a last four symbols of a slot that includes the PSCCH/PSSCH.

Example 8 includes the subject matter of any of examples 1-7, including or omitting optional elements, wherein the baseband processor is configured to transmit the beam tracking reference signal using a higher subcarrier spacing with respect to a subcarrier spacing used to transmit the PSCCH/PSSCH.

Example 9 includes the subject matter of any of examples 1-8, including or omitting optional elements, wherein the baseband processor is configured to transmit the beam tracking reference signal by down-sampling the beam tracking reference signal in the frequency domain.

Example 10 is a user equipment (UE), including a memory and a baseband processor coupled to the memory. The baseband processor is configured to, when executing instructions stored in the memory, receive a first beam tracking reference signal from a receiving (RX) UE; transmit physical sidelink control channel or physical sidelink shared channel (PSCCH/PSSCH) using an initial TX beam that corresponds to an optimal RX beam for receiving the first beam tracking reference signal; transmit a second beam tracking reference signal using the initial TX beam; receive a third beam tracking reference signal from the RX UE; and transmit PSCCH/PSSCH using a revised TX beam that corresponds to an optimal RX beam for receiving the third beam tracking reference signal.

Example 11 includes the subject matter of example 10, including or omitting optional elements, wherein the baseband processor is configured to transmit a beam tracking reference signal in a same slot as the PSCCH/PSSCH, wherein symbols used for transmitting the beam tracking reference signal are time domain multiplexed with respect to symbols that carry the PSCCH/PSSCH.

Example 12 includes the subject matter of any of examples 10-11, including or omitting optional elements, wherein the baseband processor is configured to transmit the beam tracking reference signal in a last four symbols of a slot that includes the PSCCH/PSSCH.

Example 13 includes the subject matter of any of examples 10-12, including or omitting optional elements, wherein the baseband processor is configured to transmit the beam tracking reference signal using a higher subcarrier spacing with respect to a subcarrier spacing used to transmit the PSCCH/PSSCH.

Example 14 includes the subject matter of any of examples 10-13, including or omitting optional elements, wherein the baseband processor is configured to transmit the beam tracking reference signal by down-sampling the beam tracking reference signal in the frequency domain.

Example 15 is a method for a user equipment (UE), including transmitting reference signals to a receiving (RX) UE using different transmit (TX) beams; receiving a signal indicative of an initial TX beam from the RX UE; transmitting physical sidelink control channel or physical sidelink shared channel (PSCCH/PSSCH) using the initial TX beam; detecting degradation of a link associated with the initial TX beam; and in response, selecting a revised TX beam for transmitting subsequent PSCCH/PSSCH to the RX UE.

Example 16 includes the subject matter of example 15, including or omitting optional elements, including detecting the degradation of the link associated with the initial TX beam based on a change in orientation of the UE.

Example 17 includes the subject matter of any of examples 15-16, including or omitting optional elements, further including sensing a change in orientation of the UE with respect to a global TX axis, wherein the global TX axis is aligned with the initial TX beam; and selecting a TX beam having a local TX axis that is aligned with the global TX axis as the revised TX beam.

Example 18 includes the subject matter of any of examples 15-17, including or omitting optional elements, further including sensing a change in orientation of the UE; and based on the change in orientation, transmitting a TX wide beam selection related reference signal or a TX narrow beam selection related reference signal to trigger selection of the revised TX beam.

Example 19 includes the subject matter of any of examples 15-18, including or omitting optional elements, further including periodically transmitting a beam tracking reference signal; and detecting the degradation of the link based on feedback with respect to the beam tracking reference signal from the RX UE.

Example 20 includes the subject matter of any of examples 15-19, including or omitting optional elements, further including transmitting a beam tracking reference signal in a same slot as the PSCCH/PSSCH, wherein symbols used for transmitting the beam tracking reference signal are time domain multiplexed with respect to symbols that carry the PSCCH/PSSCH.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A user equipment (UE), comprising:
a memory; and
a baseband processor coupled to the memory, the baseband processor configured to, when executing instructions stored in the memory, cause the UE to:
transmit reference signals to a receiving (RX) UE using different transmit (TX) beams;
receive a signal indicative of an initial TX beam from the RX UE;
detect degradation of a link associated with the initial TX beam; and
in response, select a revised TX beam for transmitting subsequent sidelink transmissions to the RX UE.

2. The UE of claim 1, wherein the degradation of the link associated with the initial TX beam is detected based on a change in orientation of the UE.

3. The UE of claim 1, wherein the baseband processor is configured to
sense a change in orientation of the UE with respect to a global TX axis, wherein the global TX axis is aligned with the initial TX beam; and
select a TX beam having a local TX axis that is aligned with the global TX axis as the revised TX beam.

4. The UE of claim 1, wherein the baseband processor is configured to
sense a change in orientation of the UE; and
based on the change in orientation, transmit a TX wide beam selection related reference signal or a TX narrow beam selection related reference signal to trigger selection of the revised TX beam.

5. The UE of claim 1, wherein the baseband processor is configured to
periodically transmit a beam tracking reference signal; and
detect the degradation of the link based on feedback with respect to the beam tracking reference signal from the RX UE.

6. The UE of claim 1, wherein the baseband processor is configured to transmit a beam tracking reference signal in a same slot as a sidelink transmission, wherein symbols used for transmitting the beam tracking reference signal are time domain multiplexed with respect to symbols that carry the sidelink transmission.

7. The UE of claim 1, wherein the baseband processor is configured to transmit a beam tracking reference signal in a last four symbols of a slot that includes a sidelink transmission.

8. The UE of claim 7, wherein the baseband processor is configured to transmit the beam tracking reference signal using a higher subcarrier spacing with respect to a subcarrier spacing used to transmit a sidelink transmission.

9. The UE of claim 7, wherein the baseband processor is configured to transmit the beam tracking reference signal by down-sampling the beam tracking reference signal in the frequency domain.

10. A baseband processor, configured to:
receive a first beam tracking reference signal from a receiving (RX) UE;
cause transmission of sidelink transmissions using an initial TX beam that corresponds to an optimal RX beam for receiving the first beam tracking reference signal;
transmit a second beam tracking reference signal using the initial TX beam;
receive a third beam tracking reference signal from the RX UE; and
cause transmission of sidelink transmissions using a revised TX beam that corresponds to an optimal RX beam for receiving the third beam tracking reference signal.

11. The baseband processor of claim 10, configured to cause transmission of a beam tracking reference signal in a same slot as a sidelink transmission, wherein symbols used for transmitting the beam tracking reference signal are time domain multiplexed with respect to symbols that carry a sidelink transmission.

12. The baseband processor of claim 11, configured to cause transmission of the beam tracking reference signal in a last four symbols of a slot that includes the sidelink transmission.

13. The baseband processor of claim 11, configured to cause transmission of the beam tracking reference signal using a higher subcarrier spacing with respect to a subcarrier spacing used to transmit the sidelink transmission.

14. The baseband processor of claim 11, configured to cause transmission of the beam tracking reference signal by down-sampling the beam tracking reference signal in the frequency domain.

15. A method for a user equipment (UE), comprising:
transmitting reference signals to a receiving (RX) UE using different transmit (TX) beams;
receiving a signal indicative of an initial TX beam from the RX UE;
detecting degradation of a link associated with the initial TX beam; and
in response, selecting a revised TX beam for transmitting subsequent sidelink transmissions to the RX UE.

16. The method of claim 15, comprising detecting the degradation of the link associated with the initial TX beam based on a change in orientation of the UE.

17. The method of claim 15, further comprising:
sensing a change in orientation of the UE with respect to a global TX axis, wherein the global TX axis is aligned with the initial TX beam; and
selecting a TX beam having a local TX axis that is aligned with the global TX axis as the revised TX beam.

18. The method of claim 15, further comprising:
sensing a change in orientation of the UE; and
based on the change in orientation, transmitting a TX wide beam selection related reference signal or a TX narrow beam selection related reference signal to trigger selection of the revised TX beam.

19. The method of claim 15, further comprising:
periodically transmitting a beam tracking reference signal; and
detecting the degradation of the link based on feedback with respect to the beam tracking reference signal from the RX UE.

20. The method of claim 15, further comprising transmitting a beam tracking reference signal in a same slot as a sidelink transmission, wherein symbols used for transmitting the beam tracking reference signal are time domain multiplexed with respect to symbols that carry the sidelink transmission.
